(19) United States
(12) Patent Application Publication
(10) Pub. No.: US 2016/0162146 A1
(43) Pub. Date: Jun. 9, 2016

(54) METHOD AND SYSTEM FOR MOBILE DEVICE AIRSPACE ALTERNATE GESTURE INTERFACE AND INVOCATION THEREOF

(71) Applicant: Kobo Incorporated, Toronto (CA)

(72) Inventor: James WU, Newmarket (CA)

(73) Assignee: Kobo Incorporated, Toronto (CA)

(21) Appl. No.: 14/560,473

(22) Filed: Dec. 4, 2014

(51) Int. Cl. G06F 3/0488; G06F 3/0484; G06F 3/0482; G06F 3/0483; G06F 3/041

(52) U.S. Cl. CPC G06F 3/0488; G06F 3/0483; G06F 3/0416; G06F 3/0482; G06F 3/04842

(57) ABSTRACT

A computing device, or electronic personal display, includes a housing and a touch screen display. The housing includes a 3-dimension motion sensor operational within an airspace thereof. The processor is capable of detecting a presence of one or more extraneous objects on the display screen. In response to detecting the presence of the one or more extraneous objects on the display screen, an the input command is dissociated from a touch-based gesture interface, and instead is re-associated via re-mapping to an airspace gesture received at the computing device for performing a given output operation.

### TECHNICAL FIELD

Examples described herein relate to a system and method for transitioning a mobile computing device to alternate mode of operation via an airspace gesture interface.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device provided with an airspace interface for transitioning to an airspace gesture alternate mode of operation, according to an embodiment.

FIG. 2 illustrates an example arrangement of a 3D airspace motion sensor providing an airspace interface of a computing device for transitioning to an airspace gesture alternate mode of operation, according to an embodiment.

FIG. 3 illustrates a schematic configuration of a computing device for transitioning to an airspace gesture alternate mode of operation, according to an embodiment.

FIG. 4 illustrates a method of operating a computing device for transitioning to an airspace interface gesture alternate mode of operation, according to an embodiment.

### DETAILED DESCRIPTION

Embodiments described herein provide for a computing device that is operable even when water and/or other persistent objects are present on the surface of a display of the computing device. More specifically, the computing device may detect a presence of extraneous objects (e.g., such as water, dirt, or debris) on a surface of the display screen, and perform one or more operations to mitigate or overcome the presence of such extraneous objects in order to maintain a functionality for use as intended, and for viewing of content displayed on the display screen. For example, upon detecting the presence of one or more extraneous objects, such as water droplets, debris or dirt, certain settings or configurations of the computing device may be automatically adjusted, thereby invoking operation via an alternate user interface based on an airspace gesture action, whereby gestures from the display touchscreen-based interface mode of operation are nullified or dissociated as valid user input commands to perform a given processor output operation; in lieu thereof, an alternate user interface using the airspace gesture action becomes associated with, and capable of, effecting the processor output operation.

“E-books” are a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete successive pages.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

### System and Hardware Description

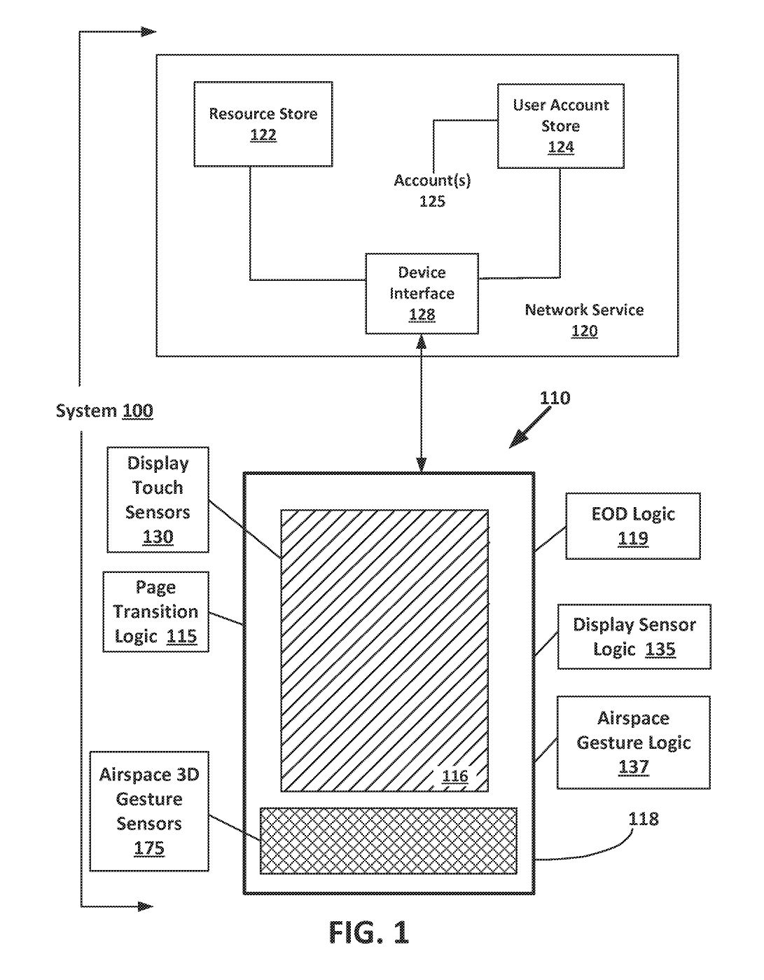

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services in communication with e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the c-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with a user account 125. The user account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the resource store 122, which can include, for example, an online store. The device interface 128 can handle input to identify content items (e.g., e-books), and further to link content items to the user account 125.

Yet further, the user account store 124 can retain metadata for the individual user account 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display 116 and a housing 118. In an embodiment, the display 116 is touch-sensitive, to process touch inputs including gestures (e.g., swipes). For example, the display 116 may be integrated with one or more touch sensors 130 to provide a touch-sensing region on a surface of the display 116. For some embodiments, the one or more touch sensors 130 may include capacitive sensors that can sense or detect a human body's capacitance as input. In the example of FIG. 1, the touch-sensing region coincides with a substantial surface area, if not all, of the display 116.

In addition to touch-sensitive display 116, the housing 118 of the electronic personal device, tablet or e-reader can also be integrated with three dimensional (3D) motion sensor 175 for sensing motion of an observer's hand, palm or finger in performance of a gesture action in appropriate airspace region proximate 3D motion sensors 175. 3D motion sensors 175 will interchangeably be referred to herein as 3D motion sensor 175. 3D motion sensor 175 may be disposed on the bezel, front surface, a lateral surface or edge, and/or a rear surface of the housing 118. 3D motion sensors 175, in an embodiment, may be implemented using infrared-based motion sensing that operates to sense an input object breaking one or more infrared beams that are projected over a surface of housing 118.

For purposes of the following discussion, the 3D motion sensor 175 refers to a device or component that monitors a portion of airspace. When motion is detected within the portion of monitored airspace, the motion is mapped and compared with a number of predefined gestures. Each of the predefined gestures may also be associated with an input operation received at e-reading device 110.

In some embodiments, the e-reading device 110 includes airspace gesture logic 137 that acts on for airspace gesture input as monitored via the 3D motion sensor 175 by identifies the input as a particular airspace gesture input. In general, when the recognized airspace motion as monitored by 3D motion sensor 175 correlates with a pre-defined gesture, airspace gesture logic 137 instructs a processor of the eReader that the associated operation should be performed. In one implementation, the airspace gesture logic 137 can be integrated with the 3D motion sensors 175. For example, the 3D motion sensor 175 can be provided as a modular component that includes integrated circuits or other hardware logic, and such resources can provide some or all of the airspace gesture logic 137. For example, integrated circuits of the 3D motion sensor 175 can monitor for an airspace gesture input and process that input as being of a particular kind.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116.

According to some embodiments, the e-reading device 110 includes display sensor logic 135 to detect and interpret user input or user input commands made through interaction with the display screen touch sensors 130. By way of example, the display sensor logic 135 can detect a user making contact with the touch-sensing region of the display 116. More specifically, the display sensor logic 135 can detect taps, an initial tap held in sustained contact or proximity with display 116 (otherwise known as a “long press”), multiple taps, and/or swiping gesture actions made through user interaction with the touch sensing region of the display 116. Furthermore, the display sensor logic 135 can interpret such interactions in a variety of ways. For example, each interaction may be interpreted as a particular type of user input for effecting a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 175 as a type of non-user input. For example, the multi-sensor contact may be provided, in part, by water and/or other unwanted or extraneous objects (e.g., dirt, debris, etc.) interacting with the touch sensors 130. Specifically, the e-reading device 110 may then determine, based on the multi-sensor contact, that at least a portion of the multi-sensor contact is attributable to presence of water and/or other extraneous objects on the surface of the display 116.

E-reading device 110 further includes airspace gesture logic 137 to interpret user input gestures as commands based on detection by airspace gesture sensor(s) 136 at gesture sensitive housing portion 132. For example, input gestures performed at gesture sensitive housing portion 132 of c-reading device 110 such as a tap, a directional swipe, and a series of taps may be detected via 3D motion sensor 175 and interpreted as respective input commands by airspace gesture logic 137.

E-reading device 110 further includes extraneous object detection (EOD) logic 119 to adjust one or more settings of the e-reading device 110 to account for the presence of water and/or other extraneous objects being in contact with the display 116. For example, upon detecting the presence of water and/or other extraneous objects on the surface of the display 116, the EOD logic 119 may power off the e-reading device 110 to prevent malfunctioning and/or damage to the e-reading device 110. EOD logic 119 may then reconfigure the e-reading device 110 by invalidating or dissociating a touch screen gesture from being interpreted as a valid input command, and in lieu thereof, associate an alternative type of user interactions as valid input commands, e.g., motion inputs that are detected via the gesture sensor(s) 136 will now be associated with any given input command previously enacted via the touch sensors 130 and display sensor logic 135. This enables a user to continue operating the e-reading device 110 even with the water and/or other extraneous objects present on the surface of the display 116, albeit by using the alternate type of user interaction.

One or more embodiments of airspace gesture logic 137 and EOC logic 119 as described herein may be implemented by e-reading device 110 using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments of airspace gesture logic 137 and EOC logic 119 as described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

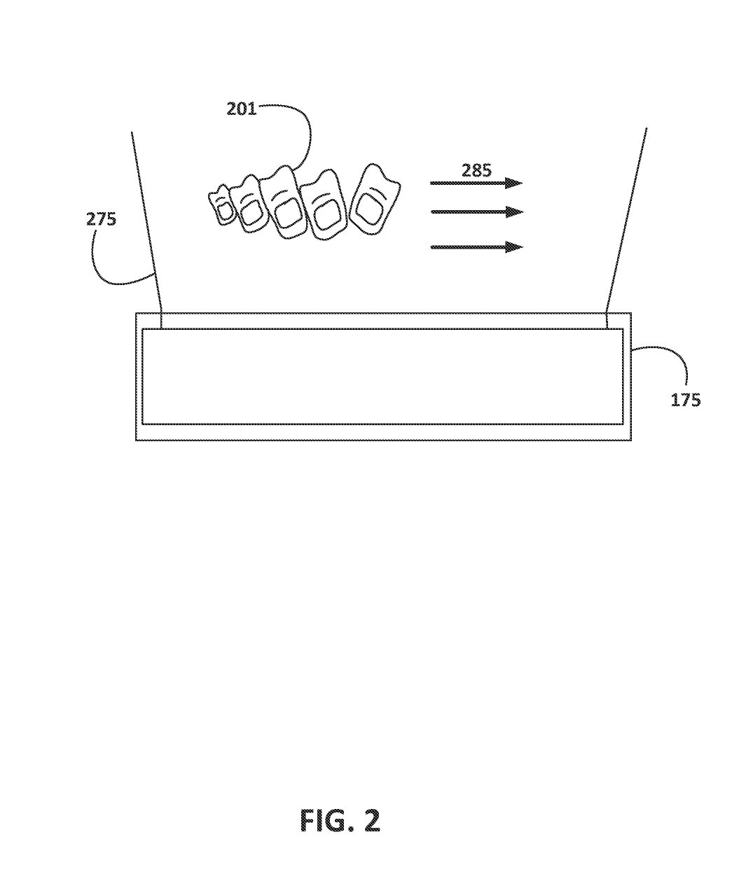

FIG. 2 shows a 3D motion sensor 175 with an airspace 275 within which motion may be sensed to receive user input at e-reading device 110. In various embodiments one or more 3D motion sensor 175 may be included in e-reading device 110 in order to receive user input from input object 201 such as styli or human digits. For example, in response to a motion 285 within the airspace 275, user input from one or more fingers may be detected by 3D motion sensor 175 and interpreted via airspace gesture logic 137. Such user input may be used to interact with graphical content displayed on display 116 and/or to provide other input through various gestures. In general, 3D motion sensor 175 may recognize motions performed in one or more of the x-, y- and z-axis. For example, a side-to-side motion would be differentiated from an up and down motion. Moreover, depending on the desired granularity of the 3D motion sensor 175 additional differentiations may be made between a horizontal side-to-side motion and a sloping side-to-side motion. In one embodiment, the 3D motion sensor 175 may be incorporated with digital camera disposed in housing 118 into a single device.

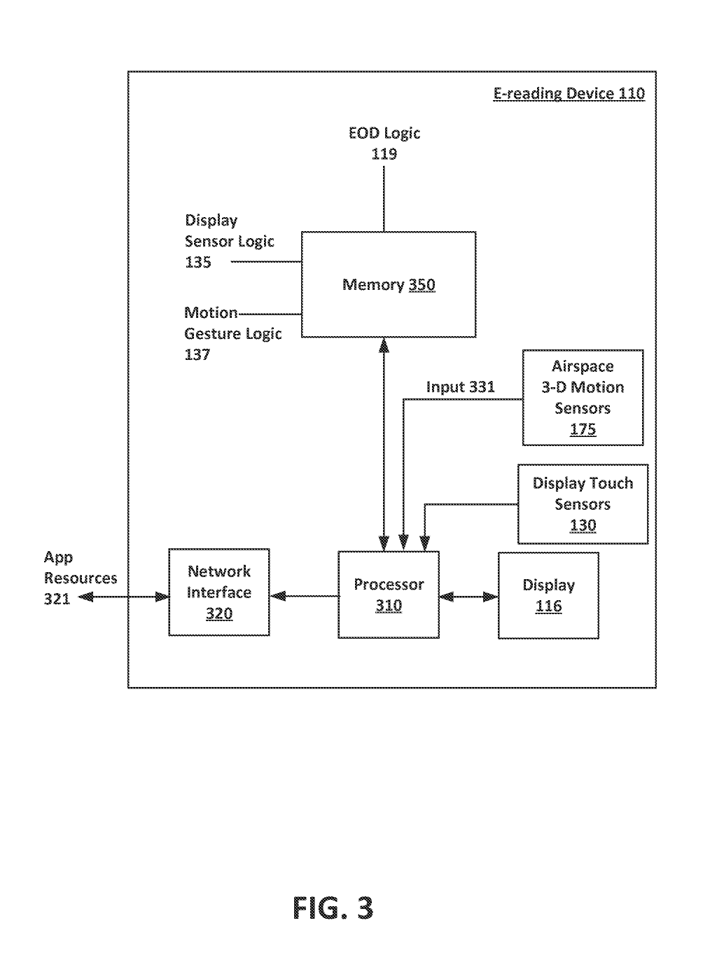

FIG. 3 illustrates a schematic architecture, in one embodiment, of e-reading device 110 as described above with respect to FIGS. 1 and 2. With reference to FIG. 3, e-reading device 110 further includes a processor, a memory 350 storing instructions, and logic pertaining at least to display sensor logic 135, EOD logic 119 and airspace gesture logic 137.

The processor 310 can implement functionality using the logic and instructions stored in the memory 350. Additionally, in some implementations, the processor 310 utilizes the network interface 320 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 321, such as e-books or media files, that the user elects to purchase or otherwise download via the network service 120. The application resources 321 that are downloaded onto the e-reading device 110 can be stored in the memory 350.

In some implementations, the display 116 can correspond to, for example, a liquid crystal display (LCD) or light emitting diode (LED) display that illuminates in order to provide content generated from processor 310. In some implementations, the display 116 can be touch-sensitive. For example, in some embodiments, one or more of the touch sensor 130 may be integrated with the display 116. In other embodiments, the touch sensor 130 may be provided (e.g., as a layer) above or below the display 116 such that individual touch sensor 130 tracks different regions of the display 116. Further, in some variations, the display 116 can correspond to an electronic paper type display, which mimics conventional paper in the manner in which content is displayed. Examples of such display technologies include electrophoretic displays, electro-wetting displays, and electro-fluidic displays.

The processor 310 can receive input from various sources, including the touch sensor 130 of display 116, from 3D motion sensor 175 at housing 118 and/or other input mechanisms (e.g., buttons, keyboard, mouse, microphone, etc.). With reference to examples described herein, the processor 310 can respond to input 331 detected at 3D motion sensor 175. In some embodiments, the processor 310 responds to inputs 331 from the 3D motion sensor 175 in order to facilitate or enhance e-book activities such as generating e-book content on the display 116, performing page transitions of the displayed e-book content, powering on or off e-reading device 110 and/or display 116, activating a screen saver, launching or closing an application, and/or otherwise altering a state of the display 116.

Still with reference to FIG. 3 and the examples described herein, the processor 310 can respond to input 331 from the 3D motion sensor 175. In some embodiments, the e-reading device 110 includes airspace gesture logic 137 that acts in conjunction with processor 310 to respond to airspace gesture inputs as monitored via 3D motion sensor 175, and further processes the input as a particular input or type of input.

In some embodiments, the memory 350 may store display sensor logic 135 that monitors for user interactions detected through the touch sensor 130 of the display screen, and further processes the user interactions as a particular input or type of input.

For some embodiments, the display sensor logic 135 may detect the presence of water and/or other extraneous objects, including debris and dirt, on the surface of the display 116. For example, the display sensor logic 135 may determine that extraneous objects are present on the surface of the display 116 based on a number of touch-based interactions detected via the touch sensors 130 and/or a contact duration (e.g., a length of time for which contact is maintained with a corresponding touch sensor 130) associated with each interaction. More specifically, the display sensor logic 135 may detect the presence of water and/or other extraneous objects if a detected interaction falls outside a set of known gestures (e.g., gestures that are recognized by the e-reading device 110). Such embodiments are discussed in greater detail, for example, in co-pending U.S. patent application Ser. No. 14/498,661, titled “Method and System for Sensing Water, Debris or Other Extraneous Objects on a Display Screen,” filed Sep. 26, 2014, which is hereby incorporated by reference in its entirety.

For some embodiments, the display sensor logic 135 further operates in conjunction with airspace gesture logic 137 for adjusting one or more settings of the e-reading device 110 in response to detecting the presence of water and/or other extraneous objects on the surface of the display 116. For example, the airspace gesture logic 137 may configure the e-reading device 110 to operate in a “splash mode” when water and/or other extraneous objects are present (e.g., “splashed”) on the surface of the display 116. While operating in splash mode, one or more device configurations may be altered or reconfigured to enable the e-reading device 110 to be continuously operable via airspace gesture action even while water and/or other extraneous objects are present on the surface of the display 116. More specifically, the airspace gesture logic 137 may perform one or more operations to mitigate or overcome the presence of extraneous objects (e.g., such as water) on the surface of the display 116. Accordingly, the airspace gesture logic 137 may be activated upon detecting the presence of extraneous objects on the surface of the display 116 via EOD logic 119 in conjunction with processor 310.

For some embodiments, the airspace gesture logic 137 may reconfigure one or more actions (e.g., input responses) that are to be performed by the e-reading device 110 in response to user inputs. For example, the airspace gesture logic 137 may disable or dissociate certain actions (e.g., such as performing multi-page and/or chapter transitions) that are triggered by user touchscreen-based interactions (e.g., requiring concurrent contact at multiple distinct locations on the display 116) and/or persistent user interactions (e.g., requiring continuous contact with the touch sensors 130 over a given duration) because such interactions could be misinterpreted by the gesture logic 215 given the presence of extraneous objects on the surface of the display 116. The disabling or dissociation may be accomplished by terminating electrical power selectively to those components implicated in a portion of circuitry, using interrupt-based logic to selectively disable the components involved, such as touch sensors 130 disposed in association with display 116.

Additionally, and/or alternatively, the airspace gesture logic 137 may enable a new set of airspace gesture actions to be validated or recognized in performance of input commands to e-reading device 110. For example, the airspace gesture logic 137 may remap, or associate, one or more user input commands to a new set of 3D motion gesture actions as detected by 3D motion sensor 175. With 3D motion sensor 175 activated for use in conjunction with airspace gesture logic 137, a new set of gesture actions using human digits or styli, including sideways motions, up and down motions, depth motions, tilt motions, partial rotation motions, or any combination thereof performed within a defined airspace of e-reading device 110 may be validated or recognized, and acted upon, only when water and/or other extraneous objects are present on the surface of the display 116. The airspace gesture motion may be recognized as having a direction and/or a swipe speed of motion of the human palm or the stylus, in an embodiment.

More specifically, the new set of airspace gesture actions may enable the e-reading device 110 to operate in an optimized manner while the water and/or other extraneous objects are present.

In general, the airspace gesture-input action correlation may be factory set, user adjustable, user selectable, or the like. In one embodiment, if the user's gesture-action is not an exact match to a pre-defined gesture, but is a proximate match for the operation, the correlation settings could be widened such that a gesture with a medium correlation is recognized, or the settings could be narrowed such that only a gesture with a high correlation to the pre-defined gesture will be recognized. For example, in reader mode the correlation settings may be widened such that an open handed gesture from right to left may be indicative of a page turning operation. However, during other operations with higher correlation requirements, the same gesture may be too broad and not be recognized as correlating with any pre-defined gesture-action operations. In one embodiment, the input command to be performed may include, but not limited to, opening an e-book, closing an e-kook, turning a page, adding a bookmark on a page of text content being displayed, removing the bookmark, opening a menu, initiating a change in screen brightness, a reading mode change, initiation of a sleep mode, and a device power-off command.

Moreover, the user may expand the predefined gestures by developing and storing individualized gestures. For example, one user may define a bookmarking operation as a contact followed by a checkmark type of motion while another user may define a bookmarking operation as a contact followed by an “ok” motion. For example, a number of predefined gestures for performing operations such as, but not limited to, book opening, book closing, forward page turn, backward page turn and bookmarking may be enacted using a back of the hand, palm of the hand and knife-edge of a hand. In general, back of the hand refers to the knuckled side of a hand while palm of the hand refers to the side of a hand that includes the fingerprints. A knife-edge of a hand refers to a side portion of the hand that includes the pinkie finger and the side portion of the palm, similar to a karate chop type of hand orientation.

### Methodology

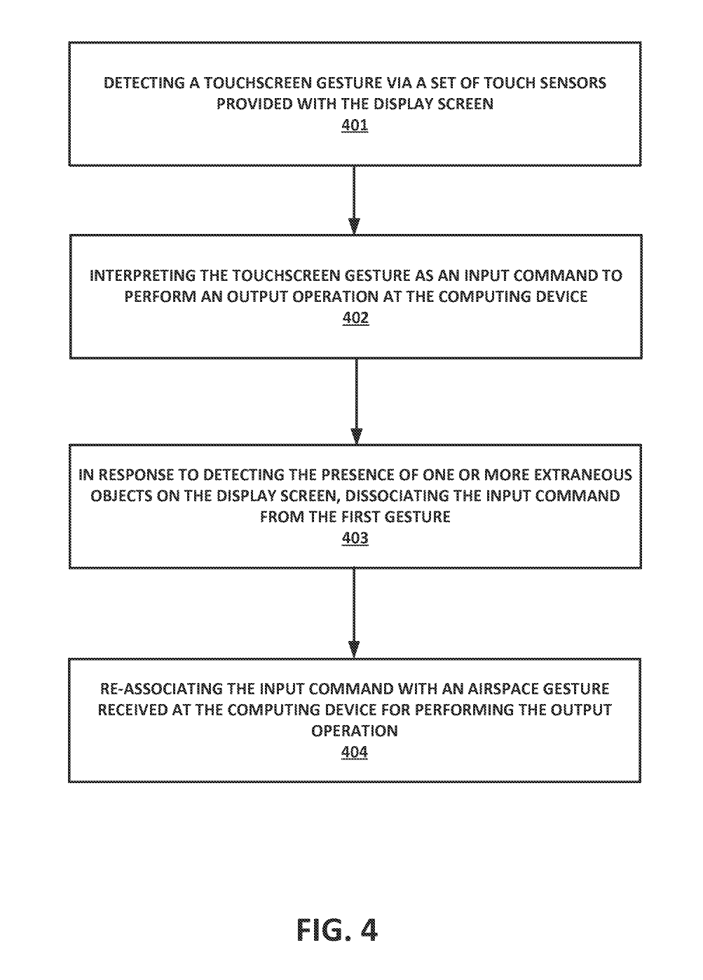

FIG. 4 illustrates a method of operating an c-reading device 110 to an alternate gesture mode when water and/or other extraneous objects are present on the display 116, according to one or more embodiments. In describing the example of FIG. 3, reference may be made to components such as described with FIGS. 1, 2 and 3 for purposes of illustrating suitable components and logic modules for performing a step or sub-step being described.

With reference to the example of FIG. 3, the e-reading device 110 may detect the presence of one or more extraneous objects on a surface of the display 116. For some embodiments, the display sensor logic 135 may detect the presence of extraneous objects on the surface of the display 116 based on a number of touch-based interactions detected via the touch sensors 130 and/or a contact duration associated with each of the interactions. For example, the display sensor logic 135 may determine that extraneous objects are present on the surface of the display 116 if a detected interaction falls outside a set of known gestures.

At step 401, a gesture upon display 116 is detected via the set of touch sensors 130 is interpreted as an input command to perform an output operation at the e-reading device 110.

At step 402, the gesture enacted at the display screen is interpreted by display sensor logic 135 as an input gesture command to perform an associated output operation, via processor 310, at e-reading device 110.

At step 403, EOD logic 119 detects the presence of one or more extraneous objects on a surface of the display 116 in response to detecting the presence of the one or more extraneous objects on the display screen, and in response thereto, airspace gesture logic 137 disables or dissociates certain user input commands associated with touch gestures such as a tap, a sustained touch, a swipe or some combination thereof, received at display 116 as detected from display touch sensors 130.

At step 404, processor 310 in conjunction with airspace gesture logic 137 then re-associates, or remaps, the set of user input commands by associating ones of the set with respective airspace gesture motion input actions as detected via 3D motion sensor 175. Example airspace gestures on the gesture sensitive housing portion 132 may include a sideways motion, an up and down motion, a depth motion, a tilt motion, a partial rotation motion, a directionally enacted arcuate swipe, or some combination thereof, as detected via 3D motion sensor 175 and interpreted by airspace gesture logic 137 to accomplish respective output operations for e-reading actions, such as turning a page (whether advancing or backwards), placing a bookmark on a given page or page portion, placing the e-reader device in a sleep state, a power-on state or a power-off state, and navigating from the e-book being read to access and display an e-library collection of e-books that may be associated with user account store 124.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method executed in a processor of a computing device, the computing device including a memory storing instructions and a display screen having touch functionality, the processor capable of detecting a presence of one or more extraneous objects on the display screen, the method comprising:
detecting a touchscreen gesture enacted upon a set of touch sensors provided with the display screen;
interpreting the touchscreen gesture as an input command to perform an output operation at the computing device;
in response to detecting the presence of the one or more extraneous objects on the display screen, dissociating the input command from the touchscreen gesture; and
re-associating the input command with an airspace gesture received at the computing device for performing the output operation.

2. The method of claim 1, wherein the touchscreen gesture is interpreted as an input command to enact a page transition operation upon digital content displayable as a sequence of pages upon the display screen.

3. The method of claim 1 wherein the airspace gesture received in airspace proximate the computing device is one of a sideways motion, an up and down motion, a depth motion, a tilt motion, and a partial rotation motion.

4. The method of claim 3 wherein the output operation comprises a bookmark operation associated with a page in a sequence of pages.

5. The method of claim 3 wherein the output operation comprises a return to an e-library collection of e-books.

6. The method of claim 1, wherein the output operation comprises a sleep mode state change of the computing device.

7. The method of claim 1, wherein the output operation comprises a power-off state change of the computing device.

8. The method of claim 1 wherein the processor detects an aspect of the airspace gesture received at a gesture-sensitive housing portion as having one of a direction and a swipe speed.

9. The method of claim 1 wherein the computing device includes a 3-dimensional motion sensor set, the set being implemented using infrared-based motion sensing that operates to sense an input object breaking one or more infrared beams that are projected over a surface of the computing device.

10. A computing device comprising:
a display screen including touch functionality;
a housing that at least partially circumvents the display screen, the housing including a gesture sensitive portion; and
a processor provided within the housing that detects a presence of one or more extraneous objects on the display screen, the processor further operable to:
detect a touchscreen gesture via a set of touch sensors provided with the display screen;
interpret the touchscreen gesture as an input command to perform an output operation at the computing device;
in response to detecting the presence of the one or more extraneous objects on the display screen, dissociate the input command from the touchscreen gesture; and
re-associate the input command with an airspace gesture received at the computing device for performing the output operation.

11. The computing device of claim 10 wherein the airspace gesture consists of one of a sideways motion, an up and down motion, a depth motion, a tilt motion, and a partial rotation motion.

12. The computing device of claim 10 wherein the touchscreen gesture is interpreted as an input command to enact a page transition operation upon digital content displayable as a sequence of pages upon the display screen.

13. The computing device of claim 12 wherein the output operation comprises a bookmark operation associated with a page in the sequence of pages.

14. The computing device of claim 12 wherein the output operation comprises a return to an e-library collection of e-books.

15. The computing device of claim 10 wherein the output operation comprises a sleep mode state change of the computing device.

16. The computing device of claim 10 wherein the output operation comprises a power-off state change of the computing device.

17. The computing device of claim 10 wherein the processor detects an aspect of the airspace gesture received at a gesture-sensitive housing portion as having one of a direction and a swipe speed.

18. The computing device of claim 10 further comprising a 3-dimensional motion sensor set, the set being implemented using infrared-based motion sensing that operates to sense an input object breaking one or more infrared beams that are projected over a surface of the computing device.

19. A non-transitory computer-readable medium storing instructions that, when executed by a processor of a computing device, cause the processor to perform operations that include:
detecting a touchscreen gesture via a set of touch sensors provided with a display screen of the computing device;
interpreting the touchscreen gesture as an input command to perform an output operation at the computing device;
in response to detecting a presence of one or more extraneous objects on the display screen, dissociating the input command from the touchscreen gesture; and
re-associating the input command with an airspace gesture received at the computing device for performing the output operation.
